(19) United States
(12) Patent Application Publication
(10) Pub. No.: US 2021/0049537 A1
(43) Pub. Date: Feb. 18, 2021

(54) Vetted Payments

(71) Applicant: ADP, LLC, Roseland, NJ (US)

(72) Inventors: Michael Rothbaum, New York, NY (US); Nicolette Berthelot, New York, NY (US)

(21) Appl. No.: 16/543,321

(22) Filed: Aug. 16, 2019

(51) Int. Cl. G06Q 10/06; G06Q 50/10; G06Q 20/40

(52) U.S. Cl. CPC G06Q 10/063114; G06Q 20/4014; G06Q 50/10

(57) ABSTRACT

Vetting payments is provided. The method comprises creating a number of labor clouds, wherein each labor cloud has a number of specified membership requirements. Vendors who meet the membership requirements for each labor cloud are added to the labor clouds. A selection of a labor cloud from among the number of labor clouds is received from a customer through a user interface. A designation of a vendor and a payment request for the designated vendor are received from the customer through the interface. It is then determined if the designated vendor is a member of the selected labor cloud. Payment is held if the designated vendor is not a member of the selected labor cloud. Payment is submitted to the designated vendor according to the payment request only upon confirmation that the designated vendor has joined the selected labor cloud.

### BACKGROUND INFORMATION

### 1. Field

The present disclosure relates generally to an improved computer system and, in particular, to vetting vendors before remitting payment by filtering vendors that have met specified requirements for membership in designated labor clouds.

### 2. Background

Before remitting payment to a freelance vendor, companies typically want to ensure that the vendor has met certain requirements. These requirements might be technical in nature to ensure that the freelancer in question has the skill and knowledge required for an assignment. The requirements might also be legal to ensure the freelancer complies with company and/or governmental policies (e.g., background checks, licensure, etc.).

### SUMMARY

An illustrative embodiment provides a computer-implemented method for vetting payments. The method comprises creating a number of labor clouds, wherein each labor cloud has a number of specified membership requirements. Vendors who meet the specified membership requirements specified for each labor cloud are added to the labor clouds. A selection of a labor cloud from among the number of labor clouds is received from a customer through a user interface to form a selected labor cloud. A designation of vendor to form a designated vendor and a payment request for the designated vendor are received from the customer through the interface. It is then determined if the designated vendor is a member of the selected labor cloud. Payment is held if the designated vendor is not a member of the selected labor cloud. Payment is submitted to the designated vendor according to the payment request only upon confirmation that the designated vendor has joined the selected labor cloud.

Another illustrative embodiment provides a system for vetting payments. The system comprises a bus system, a storage device connected to the bus system, wherein the storage device stores program instructions, and a number of processors connected to the bus system, wherein the number of processors execute the program instructions to: create a number of labor clouds, wherein each labor cloud has a number of specified membership requirements; populate the labor clouds with a number of vendors who meet the specified membership requirements specified for each labor cloud; receive, through a user interface, a selection from a customer of a labor cloud from among the number of labor clouds to form a selected labor cloud; receive, through the user interface, a designation by the customer of vendor to form a designated vendor; receive, through the user interface, a payment request from the customer for the designated vendor; determine if the designated vendor is a member of the selected labor cloud; hold payment if the designated vendor is not a member of the selected labor cloud; and submit payment to the designated vendor according to the payment request only upon confirmation that the designated vendor has joined the selected labor cloud.

Another illustrative embodiment provides a computer program product for vetting payments. The computer program product comprises a number of non-volatile computer readable storage media having program instructions embodied therewith, the program instructions executable by a number of processors to perform the steps of: creating a number of labor clouds, wherein each labor cloud has a number of specified membership requirements; populating the labor clouds with a number of vendors who meet the specified membership requirements specified for each labor cloud; receiving, through a user interface, a selection from a customer of a labor cloud from among the number of labor clouds to form a selected labor cloud; receiving, through the user interface, a designation by the customer of vendor to form a designated vendor; receiving, through the user interface, a payment request from the customer for the designated vendor; determining if the designated vendor is a member of the selected labor cloud; holding payment if the designated vendor is not a member of the selected labor cloud; and submitting payment to the designated vendor according to the payment request only upon confirmation that the designated vendor has joined the selected labor cloud.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a block diagram of an information environment in accordance with an illustrative embodiment;

FIG. 2 is a block diagram of a computer system for vetting payments in accordance with an illustrative embodiment;

FIG. 3 depicts a labor cloud dashboard in a graphical user interface in accordance with an illustrative embodiment;

FIG. 4 depicts a labor cloud control panel displaying details of a labor cloud in accordance with an illustrative embodiment;

FIG. 5 depicts a labor cloud control panel displaying membership requirements of a labor cloud in accordance with an illustrative embodiment;

FIG. 6 depicts a labor cloud control panel displaying members of a labor cloud in accordance with an illustrative embodiment;

FIG. 7 depicts a labor cloud control panel displaying invitation options of a labor cloud in accordance with an illustrative embodiment;

FIG. 8 depicts a test dashboard in a graphical user interface in accordance with an illustrative embodiment;

FIG. 9 depicts an agreements dashboard in accordance with an illustrative embodiment;

FIG. 10 depicts a graphical user interface for submitting a payment request filtered according to labor cloud in accordance with illustrative embodiments;

FIG. 11 depicts a graphical user interface for submitting a payment request with options to invite workers to a labor cloud in accordance with illustrative embodiments;

FIG. 12 is a flowchart for a process of vetting payments to vendors in accordance with illustrative embodiments; and

FIG. 13 is a block diagram of a data processing system in accordance with an illustrative embodiment.

### DETAILED DESCRIPTION

The illustrative embodiments recognize and take into account one or more different considerations. For example, the illustrative embodiments recognize and take into account that companies typically want to ensure that vendors, particularly freelance vendors, meet certain requirements.

The illustrative embodiments further recognize and take into account that typically the only way to pay a worker who meets the requirements of employment is to first assign the work and then mark that work as complete. It is not possible to simply remit a payment or pay exclusively to reimburse expenses.

Illustrative embodiments provide a method and system for vetting vendors. A user (i.e. customer/employer) sets up a number of labor clouds. Membership within each labor cloud is determined by whether or not a vendor (such as a freelance independent contractor) has met specified requirements for that labor cloud. The user can decide to override and add a freelance vendor to a labor cloud even if the vendor does not meet the requirements. Labor clouds can also self-regulate and expel vendors who stop meeting membership requirements (e.g., a background check or license expires).

When creating a payment request, the user can choose to filter by labor cloud. After choosing the desired labor cloud the user can search for vendors within that labor cloud. Only vendors that are members of the designated labor cloud are returned in the search results.

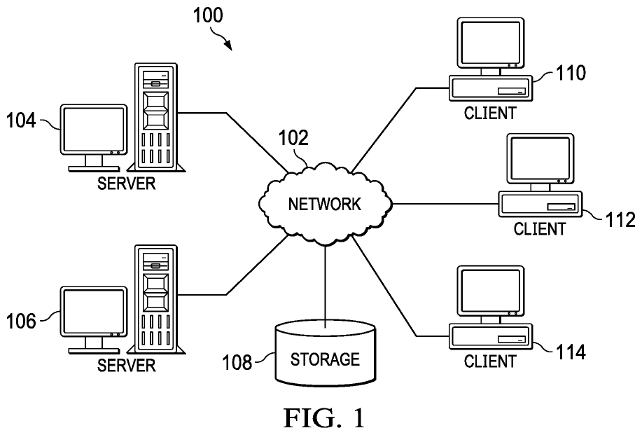

With reference now to the figures and, in particular, with reference to FIG. 1, a diagram of a data processing environment is depicted in accordance with an illustrative embodiment. It should be appreciated that FIG. 1 is only provided as an illustration of one implementation and is not intended to imply any limitation with regard to the environments in which the different embodiments may be implemented. Many modifications to the depicted environments may be made.

The computer-readable program instructions may also be loaded onto a computer, a programmable data processing apparatus, or other device to cause a series of operational steps to be performed on the computer, a programmable apparatus, or other device to produce a computer implemented process, such that the instructions which execute on the computer, the programmable apparatus, or the other device implement the functions and/or acts specified in the flowchart and/or block diagram block or blocks.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is a medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers include client computer 110, client computer 112, and client computer 114. Client computer 110, client computer 112, and client computer 114 connect to network 102. These connections can be wireless or wired connections depending on the implementation. Client computer 110, client computer 112, and client computer 114 may be, for example, personal computers or network computers. In the depicted example, server computer 104 provides information, such as boot files, operating system images, and applications to client computer 110, client computer 112, and client computer 114. Client computer 110, client computer 112, and client computer 114 are clients to server computer 104 in this example. Network data processing system 100 may include additional server computers, client computers, and other devices not shown.

Program code located in network data processing system 100 may be stored on a computer-recordable storage medium and downloaded to a data processing system or other device for use. For example, the program code may be stored on a computer-recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

The illustration of network data processing system 100 is not meant to limit the manner in which other illustrative embodiments can be implemented. For example, other client computers may be used in addition to or in place of client computer 110, client computer 112, and client computer 114 as depicted in FIG. 1. For example, client computer 110, client computer 112, and client computer 114 may include a tablet computer, a laptop computer, a bus with a vehicle computer, and other suitable types of clients.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

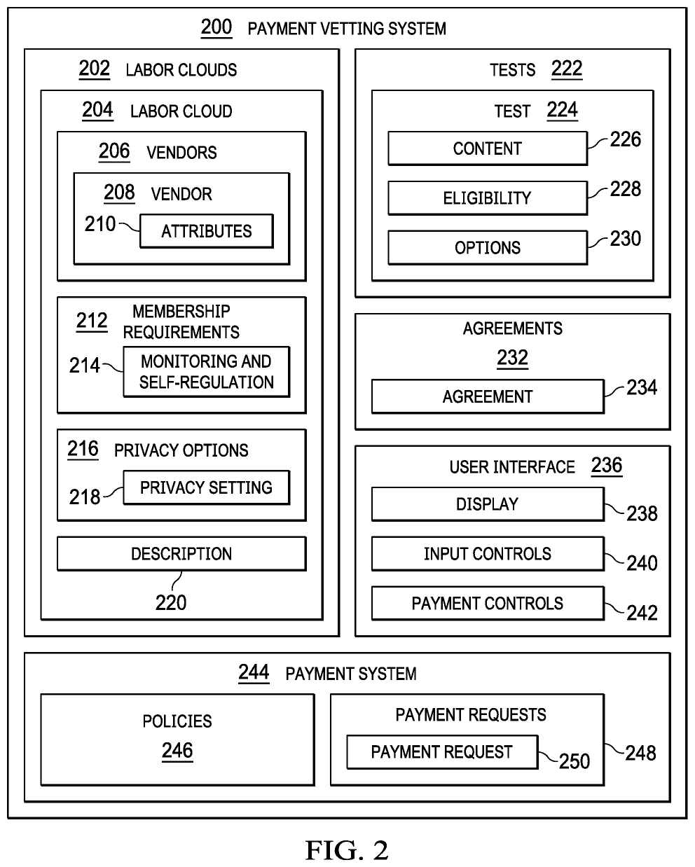

Turning to FIG. 2, a block diagram of a computer system for vetting payments is depicted in accordance with an illustrative embodiment. Payment vetting system 200 might comprise one or more server or client computers shown in FIG. 1. Payment vetting system 200 comprises a number of labor clouds 202. Labor clouds are specialized databases of vendors/workers (typically freelance independent contractors). Employers use labor clouds to identify, organize, and qualify freelance vendors with whom they would like to work. By using labor clouds 202, initial employment requirements can be presented and enforced before routing any work.

Each labor cloud 204 comprises a number of vendors 206, which can be venders 208 who are members. Each vendor 208 among the number of vendors 206 in the labor cloud 204 has a number of attributes 210. These attributes relate to ability of the vendor 208 to undertake specified types of employment for a client and include skill sets/knowledge base, credentials, certifications, licenses, availability, location, etc.

Each labor cloud 204 comprises a number of membership requirements 212 which the vendors 206 must meet in order to be members of the labor cloud 204. The membership requirements 212 can comprise more technical requirements for employment such as, e.g., skill assessment, certification, location, availability to do the work within a specified time period, the industry in question, and company type of the employer/customer, etc. Other membership requirements can comprise compliance with employer and/or governmental policy and legal requirements such as, e.g., backgrounds checks, professional insurance, licensure, signed agreements, drug testing compliance, documents/documentation (e.g., tax), eSignature, verification, and thresholds of past performance such as maximum abandoned assignments, maximum canceled assignments, and maximum one-time deliverables. The membership of vendor 208 in labor cloud 204 is dependent upon the vendor's attributes 210 meeting the specified membership requirements 212 for the labor cloud 204.

In an embodiment, the labor cloud 204 is capable of monitoring and self-regulation 214 in which vendor attributes 210 are continually or periodically monitored for compliance with the membership requirements 212. If any of the membership requirements are stop being met by the vendor 208 that vendor's membership in the labor cloud 204 is revoked. For example, a background check or professional license might lapse without being renewed, or the vendor 208 fails a drug test.

In an embodiment, the user/customer/employer has the option to manually override the membership requirements 212 of a labor cloud 204 and add a vendor 208 as a member even if the vendor's attributes 210 do not meet the membership requirements 212. This override membership might be temporary and provisional or permanent at the discretion of the employer. For example, a customer/employer might add a vendor 208 to a labor cloud 204 and create a payment request 250 for that vendor 208 despite the vendor not meeting the membership requirements 212 of the labor cloud 204. Payment might then be held until the vendor 208 complies with the membership requirements 212, depending on the policies 246 of the payment system 244.

Each labor cloud 204 can also comprise a number of privacy options 216 that control accessibility to the labor cloud. In an embodiment, privacy setting 218 can be set to public, public-unlisted, or private. A public labor cloud is accessible by any workers in the marketplace wanting to apply. A public-unlisted labor clouds are accessible only by invited workers. Private labor clouds are only accessible by the customer/employer.

Labor cloud 204 might also comprise a description 220 of the nature of employment or possible assignments from the customer/employer. Such a description can be displayed in connection with the labor cloud 204 when the privacy setting 218 is set to public or public-unlisted.

As part of meeting the membership requirements 212 for a labor cloud 204, payment vetting system 200 can comprise a number of tests 222 designed by the customer to assess knowledge and skills of potential vendors. Each test 224 among the number of tests 222 comprises content 226 specified by the employer. The test 224 might also comprise eligibility requirements 228, such as, e.g., open to the public to take versus invitation only. Test 224 might also include options 230 such as, e.g., specified time to complete, number (if any) of retakes allowed, the ability of those who pass to compare their answers with correct answers, those who fail to compare their answers with correct answers.

Payment vetting system 200 might also comprise a number of agreements 232 that each vendor 208 must sign as part of the membership requirements 212. The agreements 232 might be general agreements for the employer or specific to a work assignment. An example of an agreement 234 among the number of agreements 232 might be a non-disclosure agreement. Other examples of agreements 232 include, without limitation, independent contractor agreements, non-solicitation agreements, insurance requirement agreement, rules and regulations agreements, work for hire agreements, workers compensation agreements, and commitment agreements.

User interface 236 allows the user/customer/employer to interact with the payment vetting system 200. Display 238 and input controls 240 allow the user to create and view labor clouds 202 and information related to vendors 206, as well as to create and view tests 222 and agreements 232. Payment controls 242 allow the user to create and enter payment requests for vendors 206 in a labor cloud 204, which can be send to payment system 244.

Payment system 244 receives payment requests 248 from users/employers and processes them according to policies 246. Payment system 244 can be internal to payment vetting system 200 as shown in FIG. 2. Alternatively, payment system 244 might be an external system in communication with payment vetting system 200 via payment controls 242.

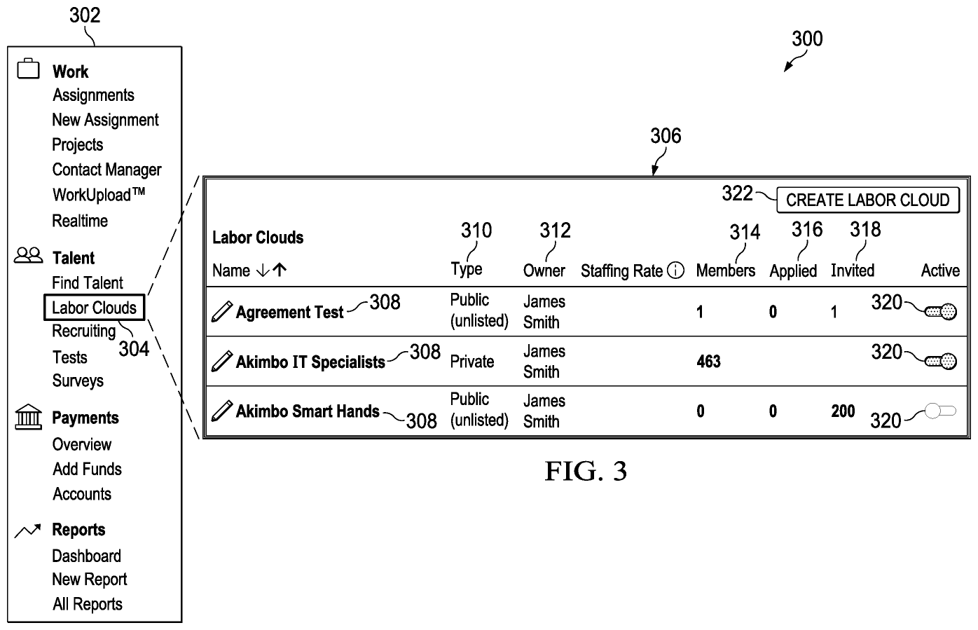

FIG. 3 depicts a labor cloud dashboard in a graphical user interface in accordance with an illustrative embodiment. Graphical user interface (GUI) 300 is an example of user interface 236 in FIG. 2. GUI 300 comprises a menu bar 302 to access different features of the payment vetting system. FIG. 3 depicts the selection of labor clouds 304 from the menu bar 302.

As a result of the selection of labor cloud dashboard 306 is displayed in GUI 300. Labor cloud dashboard 306 lists a number of labor clouds 308 by name. Each labor cloud has a type 310 indicating the privacy setting for that clouds such as public, public-unlisted, or private. Each labor cloud also has a listed owner 312. The number of members 314 is listed for each labor cloud. Labor cloud dashboard 306 might also list the number of applications 316 for membership from vendors and the number of invitations 318 sent to potential vendors, which will depend on the privacy settings of the labor cloud in question.

Labor cloud dashboard 306 might include an activation control 320 to activate or deactivate a labor cloud. There can also be a selector 322 for creating new labor clouds.

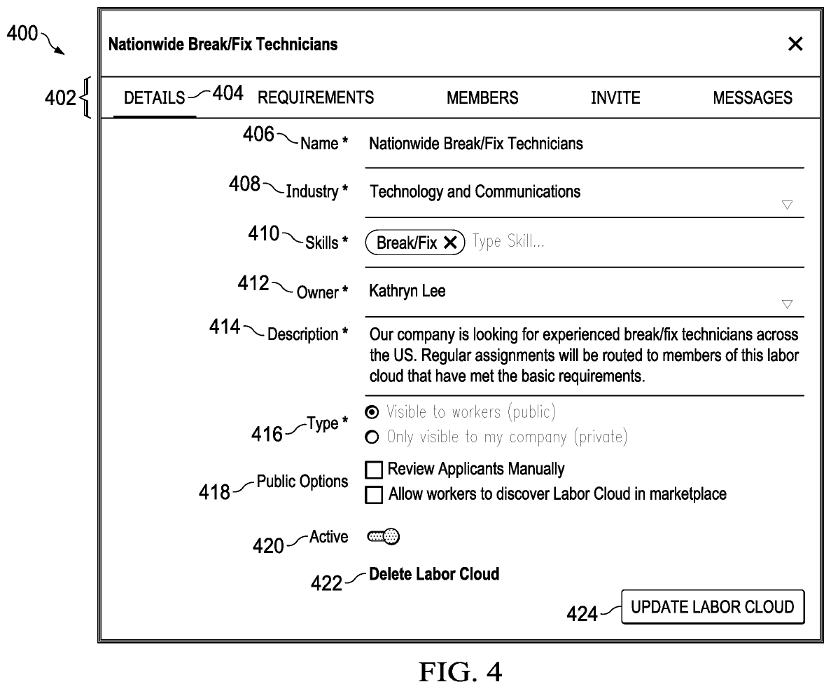

FIG. 4 depicts a labor cloud control panel displaying details of a labor cloud in accordance with an illustrative embodiment. Control panel 400 might be displayed in response to a user selecting a labor cloud in dashboard 306 in FIG. 3. At the top of control panel 400 is a menu bar 402 listing different features of the labor cloud. In the case of a private labor cloud, the menu bar 402 might not include a Requirements and Messages button.

In the example shown in FIG. 4, the control panel 400 is displaying the details 404 of the labor cloud. These details include the name of the 406 and an industry selection 408 that describes the nature and purpose of the labor cloud. Skill 410 might list relevant skills associated with the purpose of the labor cloud. Owner 412 designates a user of the labor cloud to receive notifications.

The description 414 might provide additional details about the purpose of the labor cloud beyond that found in the Industry selection 408 that are specific to the employment opportunity in question.

The type 416 indicates whether the labor cloud is public or private, reflecting the privacy options 216 in FIG. 2. For public labor clouds, there can be public options 418 to select whether the labor cloud is public-unlisted, in which applicants are reviewed manually, or completely public and discoverable by workers/vendors in the marketplace.

The active selector 420 to activate the labor cloud before inviting workers. The control panel 400 might also provide a delete option 422 if the labor cloud is no longer needed. Any changes or edits to the labor cloud can be saved by an update button 424.

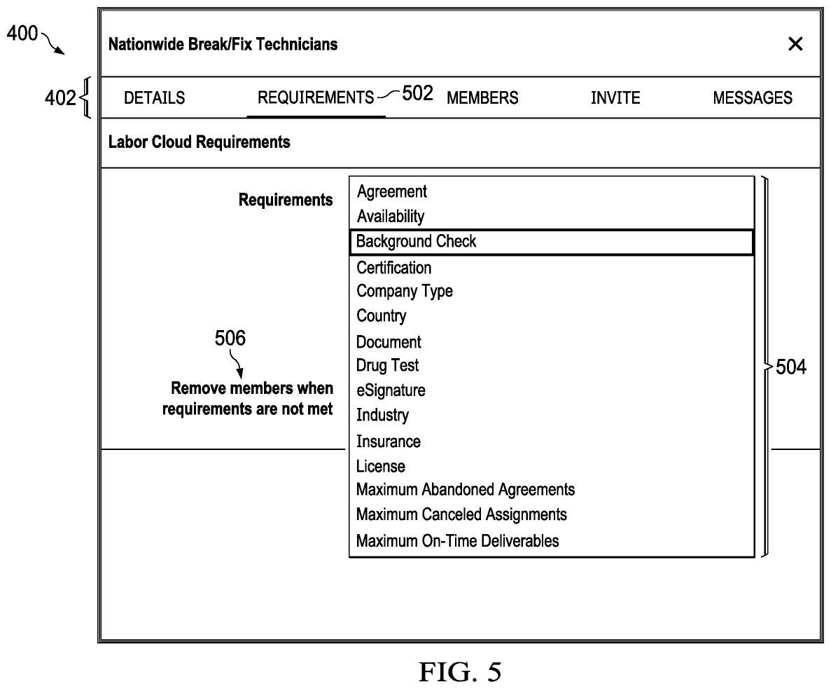

FIG. 5 depicts a labor cloud control panel displaying membership requirements of a labor cloud in accordance with an illustrative embodiment. FIG. 5 also depicts control panel 400 from FIG. 4, but in this view the Requirements tab 502 has been selected from the menus bar 402. A list of requirements 504 displays the is displayed in the control panel 400. Requirements 504 might be selected from a variety of different requirements, and the list might include as many requirements as necessary to properly qualify the worker network in the labor cloud. Requirements ensure that all vendors/workers joining the labor cloud meet specified criteria. Also shown in FIG. 5 is a monitoring and self-regulation indicator 506 that indicates the labor cloud has been set to remove member when requirements are not met, e.g., a lapsed license or background check.

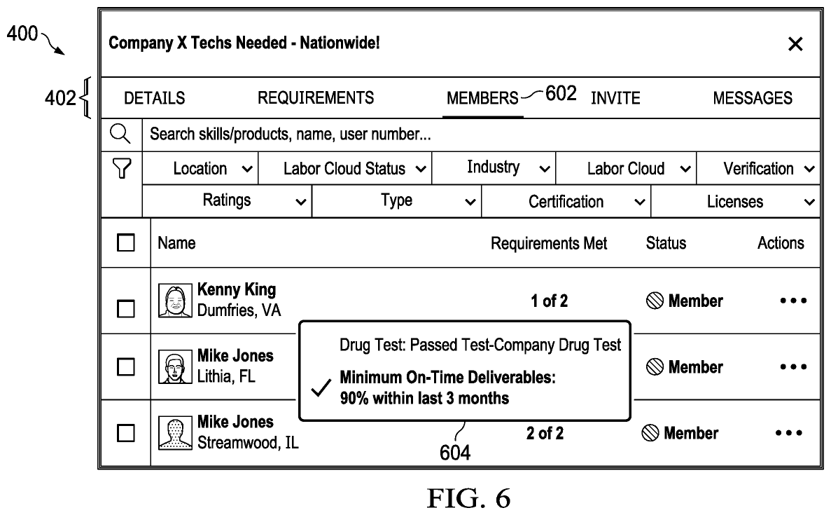

FIG. 6 depicts a labor cloud control panel displaying members of a labor cloud in accordance with an illustrative embodiment. In this example, the Members tab 602 has been selected from menu bar 402 in control panel 400. The Members tab 602 allows the user to view and sort through member, pending member, and invited workers. By selecting a member, a pop-up menu 604 might appear which outlines the membership requirements if any each worker meets and does not meet.

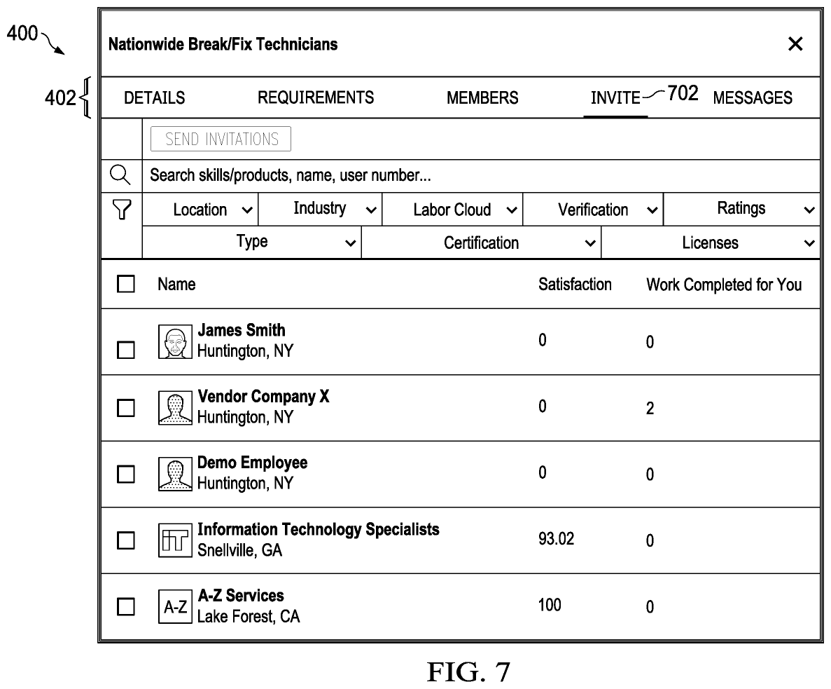

FIG. 7 depicts a labor cloud control panel displaying invitation options of a labor cloud in accordance with an illustrative embodiment. In this example, the Invite tab 702 has been selected from menu bar 402 in control panel 400. The Invite view allows the user to search the marketplace and select workers to invite to the labor cloud if the privacy setting of the labor cloud is set to public-unlisted.

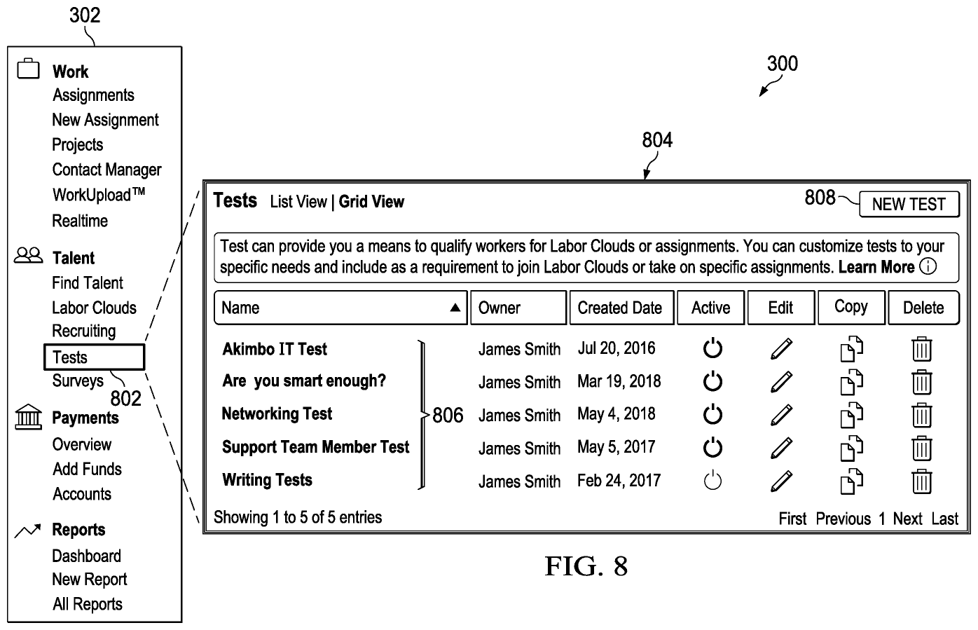

FIG. 8 depicts a test dashboard in a graphical user interface in accordance with an illustrative embodiment. FIG. 8 shows the menu bar 302 from FIG. 3, but in this example the user has selected the Tests 802. As a result, a test dashboard 804 appears in GUI 300, which lists a number of tests 802 in list 806 that have already been created. These tests might be selected as part of the membership requirements of a particular labor cloud. Creating tests allows the customer/employer to directly assess the skills and knowledge base of potential workers in a way that is specific to the needs of the employer, rather than relying on third party credential such as certifications or licenses to serve as generic proxies for such skills and knowledge. The new test button 808 allows the user to create a new test to add to list 806.

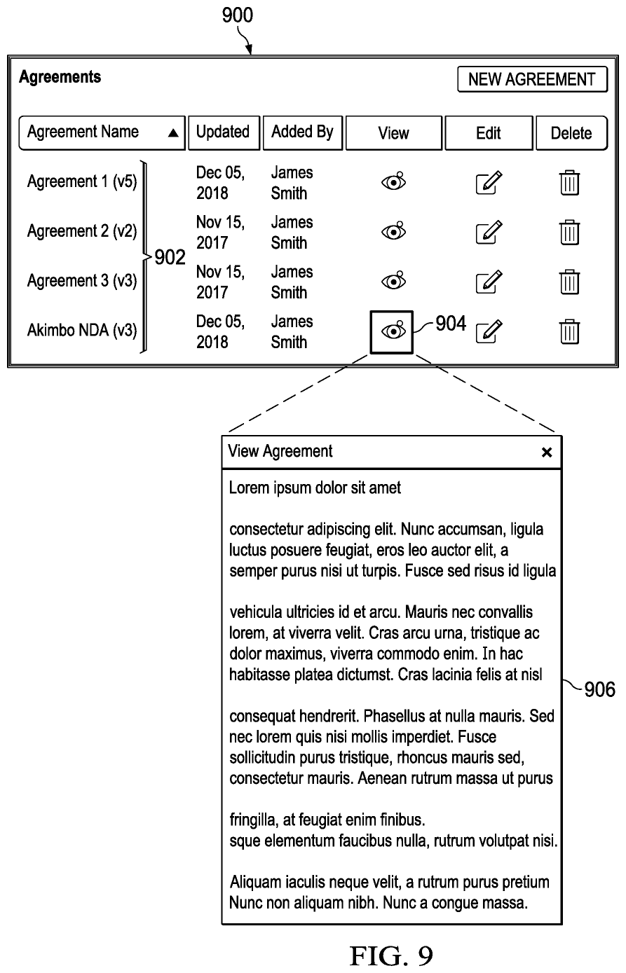

FIG. 9 depicts an agreements dashboard in accordance with an illustrative embodiment. Agreements dashboard 900 lists a number of agreements 902 that can be selected as requirements for membership in a labor cloud. Agreements 902 can be legal agreement that might be used as labor cloud membership requirements or as more specific assignment requirements. For example, a non-disclosure agreement might be required for a specific assignment but not generally required for other assignments typically encompassed by a labor cloud. In the example shown in FIG. 9, selection of the view button 904 can call up a view of the document in question, which in the present example is non-disclosure agreement 906.

Agreements 902 can establish and enforce employer policies when working with freelance independent contractors as well as ensure compliance with governmental requirements.

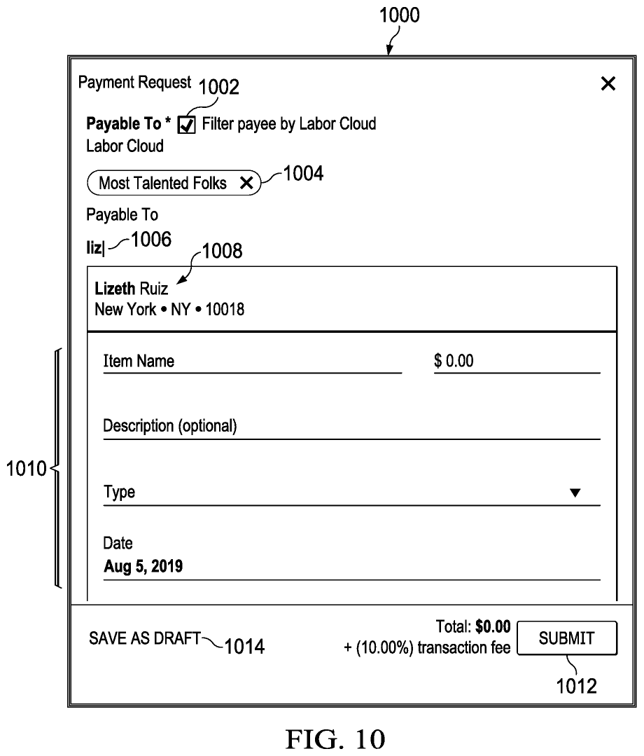

FIG. 10 depicts a graphical user interface for submitting a payment request filtered according to labor cloud in accordance with illustrative embodiments. Payment request graphical user interface 1000 is an example of user interface 236 in FIG. 2.

In this example, the payment request interface 1000 has an option selector 1002 to filter payees by labor cloud. In this example, the labor cloud 1004 titled “Most Talents Folks” is selected by the user/employer.

The user then enters the name of the intended payee in a Payable To entry field 1006. In the example shown in FIG. 10, the interface 1000 has an autofill feature that looks up the members of the selected labor cloud as the user enters the name of the payee and presents a suggested match 1008 to the user. Alternatively, payment request graphical user interface 1000 might look up and retrieve the payee information from the labor cloud only after the user has finished entering the name. If the entered payee name is not in the database of the selected labor cloud, payment request graphical user interface 1000 might return an error message or simply leave the suggested payee field blank.

Detail entry field 1010 enables the user to enter details about the job/assignment for which the selected worker is being paid as well as the payment amount. A payment button 1012 allows the user to immediately submit the payment request. Alternatively, a save button 1014 allows the user to save the payment request as a draft. If the user edits and/or submits the draft payment request at a later date, the vetting system can alert the user if the worker in question is no longer a member of the labor cloud.

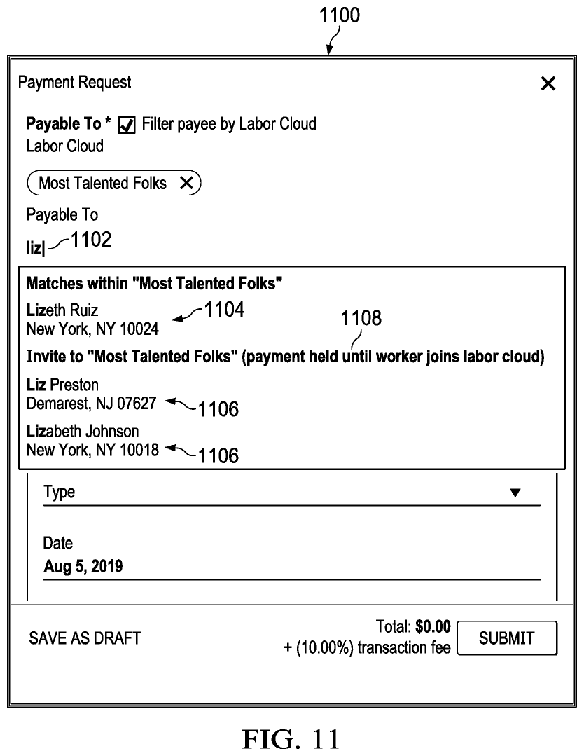

FIG. 11 depicts a graphical user interface for submitting a payment request with options to invite workers to a labor cloud in accordance with illustrative embodiments. The features and operation of payment request interface 1100 are similar to those of payment request graphical user interface 1000 in FIG. 10. However, in this embodiment, payment request interface 1100 presents the user with option to invite workers to the selected labor cloud.

As the user begins entering a name in the payee field 1102, an autofill feature of payment request interface 1100 cross-references and looks up names in the database of the selected labor cloud (i.e. Most Talented Folks) as well as other databases (e.g., other labor clouds or a general worker database). In the example shown in FIG. 11, payment request interface 1100 finds a match 1104 within the selected labor cloud as well as two matches 1106 that are not in the labor cloud but can be invited to join if selected. Payment request Interface 1100 might also present and notice 1108 that payment will be held until the worker joins the selected labor cloud.

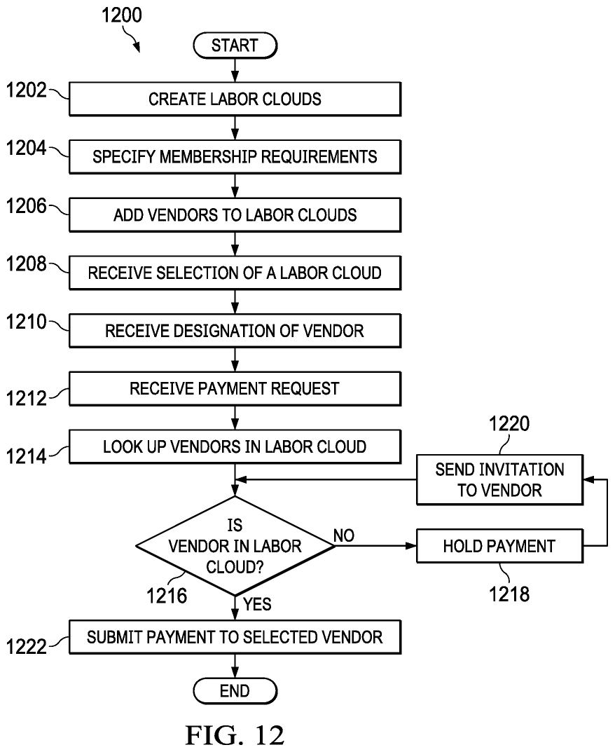

FIG. 12 is a flowchart for a process of vetting payments to vendors in accordance with illustrative embodiments. Process 1200 can be implemented by a payment vetting system such as payment vetting system 200 in FIG. 2. Process 1200 begins with the creation of a number of labor clouds (step 1202) and specifying a number of membership requirements for each labor cloud (step 1204). The labor clouds are then populated with a number of vendors who meet the membership requirements specified for each labor cloud (step 1206).

The vetting system receives a selection from a customer/employer through an interface of a labor cloud from among the number of labor clouds (step 1208). The selected labor cloud serves as a mechanism of filtering which vendors/workers are eligible to receive payment from the employer.

The vetting system receives a designation by the customer through the interface of a vendor (step 1210) and a payment request for the designated vendor (step 1212). The vetting system looks up vendors belonging to the selected labor cloud (step 1214).

The processing of the payment request will depend on whether or not the designated vendor is a member of the selected labor cloud (step 1216). If the designated vendor is not a member of the selected labor cloud, the vetting system places a hold on the payment (step 1218). The customer/employer can then send an invitation through the interface for the vendor to join the selected labor cloud (step 1220).

Once the vendor joins the labor cloud, or if the vendor was already a member of the labor cloud, the system submits payment to the vendor (step 1222).

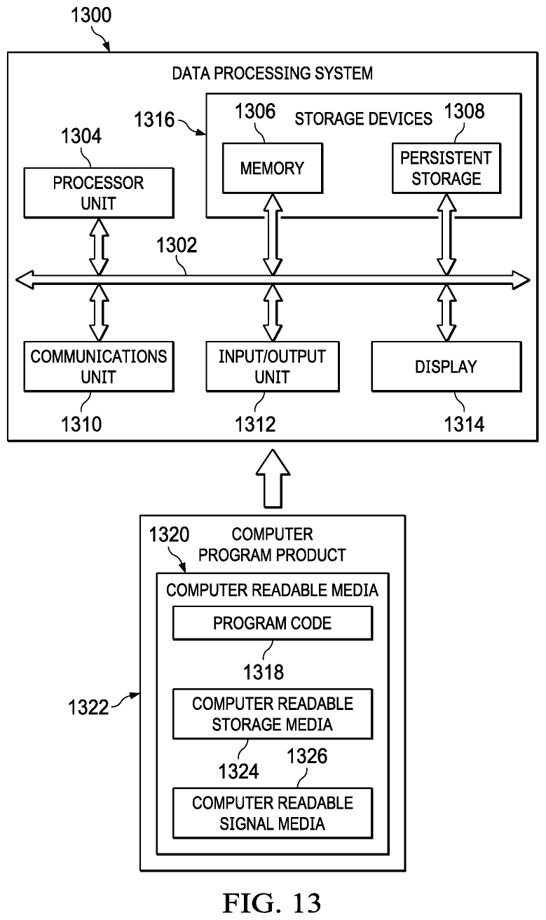

Turning now to FIG. 13, a block diagram of a data processing system is depicted in accordance with an illustrative embodiment. Data processing system 1300 may be used to implement one or more computers and client computer system 112 in FIG. 1. In this illustrative example, data processing system 1300 includes communications framework 1302, which provides communications between processor unit 1304, memory 1306, persistent storage 1308, communications unit 1310, input/output unit 1312, and display 1314. In this example, communications framework 1302 may take the form of a bus system.

Processor unit 1304 serves to execute instructions for software that may be loaded into memory 1306. Processor unit 1304 may be a number of processors, a multi-processor core, or some other type of processor, depending on the particular implementation. In an embodiment, processor unit 1304 comprises one or more conventional general purpose central processing units (CPUs). In an alternate embodiment, processor unit 1304 comprises a number of graphical processing units (CPUs).

Memory 1306 and persistent storage 1308 are examples of storage devices 1316. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1316 may also be referred to as computer-readable storage devices in these illustrative examples. Memory 1306, in these examples, may be, for example, a random access memory or any other suitable volatile or non-volatile storage device. Persistent storage 1308 may take various forms, depending on the particular implementation.

For example, persistent storage 1308 may contain one or more components or devices. For example, persistent storage 1308 may be a hard drive, a flash memory, a rewritable optical disk, a rewritable magnetic tape, or some combination of the above. The media used by persistent storage 1308 also may be removable. For example, a removable hard drive may be used for persistent storage 1308. Communications unit 1310, in these illustrative examples, provides for communications with other data processing systems or devices. In these illustrative examples, communications unit 1310 is a network interface card.

Input/output unit 1312 allows for input and output of data with other devices that may be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs may be located in storage devices 1316, which are in communication with processor unit 1304 through communications framework 1302. The processes of the different embodiments may be performed by processor unit 1304 using computer-implemented instructions, which may be located in a memory, such as memory 1306.

These instructions are referred to as program code, computer-usable program code, or computer-readable program code that may be read and executed by a processor in processor unit 1304. The program code in the different embodiments may be embodied on different physical or computer-readable storage media, such as memory 1306 or persistent storage 1308.

Program code 1318 is located in a functional form on computer-readable media 1320 that is selectively removable and may be loaded onto or transferred to data processing system 1300 for execution by processor unit 1304. Program code 1318 and computer-readable media 1320 form computer program product 1322 in these illustrative examples. In one example, computer-readable media 1320 may be computer-readable storage media 1324 or computer-readable signal media 1326.

In these illustrative examples, computer-readable storage media 1324 is a physical or tangible storage device used to store program code 1318 rather than a medium that propagates or transmits program code 1318. Alternatively, program code 1318 may be transferred to data processing system 1300 using computer-readable signal media 1326.

Computer-readable signal media 1326 may be, for example, a propagated data signal containing program code 1318. For example, computer-readable signal media 1326 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1300 are not meant to provide architectural limitations to the manner in which different embodiments may be implemented. The different illustrative embodiments may be implemented in a data processing system including components in addition to or in place of those illustrated for data processing system 1300. Other components shown in FIG. 13 can be varied from the illustrative examples shown. The different embodiments may be implemented using any hardware device or system capable of running program code 1318.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implement method of vetting payments, the method comprising:
creating, by a number of processors, a number of labor clouds, wherein each labor cloud has a number of specified membership requirements;
populating, by the number of processors, the labor clouds with a number of vendors who meet the specified membership requirements specified for each labor cloud;
receiving, by the number of processors through a user interface, a selection from a customer of a labor cloud from among the number of labor clouds to form a selected labor cloud;
receiving, by the number of processors through the user interface, a designation by the customer of vendor to form a designated vendor;
receiving, by the number of processors through the user interface, a payment request from the customer for the designated vendor;
determining, by the number of processors, if the designated vendor is a member of the selected labor cloud;
holding, by a number of processors, payment if the designated vendor is not a member of the selected labor cloud; and
submitting, by the number of processors, payment to the designated vendor according to the payment request only upon confirmation that the designated vendor has joined the selected labor cloud.

2. The method of claim 1, wherein the labor clouds self-regulate and monitor member compliance with current membership requirements.

3. The method of claim 1, wherein the customer can manually override membership requirements to add a vendor to a labor cloud.

4. The method of claim 1, further comprising:
receiving, by a number of processors through the user interface, an invitation from the customer to the designated vendor to join the selected labor cloud if the designation vendor is not a member of the selected labor cloud; and
sending, by a number of processors, the invitation to the designated vendor.

5. The method of claim 1, wherein membership requirements for a labor cloud comprise at least one of:
signed agreement;
availability;
background check;
certification;
company type;
document;
drug testing compliance;
eSignature;
industry;
insurance;
license;
location;
maximum abandoned assignments;
maximum canceled assignments;
maximum one-time deliverables;
skill assessment; and
verification.

6. The method of claim 1, wherein a number of the labor clouds are publicly accessible through an interface by any vendor.

7. The method of claim 1, wherein a number of the labor clouds are publicly accessible through an interface only by vendors invited by the customer.

8. The method of claim 1, wherein a number of the labor clouds are accessible only by the customer.

9. The method of claim 1, wherein the vendor is an independent contractor.

10. A system for vetting payments, the system comprising:
a bus system;
a storage device connected to the bus system, wherein the storage device stores program instructions; and
a number of processors connected to the bus system, wherein the number of processors execute the program instructions to:
create a number of labor clouds, wherein each labor cloud has a number of specified membership requirements;
populate the labor clouds with a number of vendors who meet the specified membership requirements specified for each labor cloud;
receive, through a user interface, a selection from a customer of a labor cloud from among the number of labor clouds to form a selected labor cloud;
receive, through the user interface, a designation by the customer of vendor to form a designated vendor;
receive, through the user interface, a payment request from the customer for the designated vendor;
determine if the designated vendor is a member of the selected labor cloud;
hold payment if the designated vendor is not a member of the selected labor cloud; and
submit payment to the designated vendor according to the payment request only upon confirmation that the designated vendor has joined the selected labor cloud.

11. The system of claim 10, wherein the labor clouds self-regulate and monitor member compliance with current membership requirements.

12. The system of claim 10, wherein the customer can manually override membership requirements to add a vendor to a labor cloud.

13. The system of claim 12, wherein the processors further execute instructions to:
receive, through the user interface, an invitation from the customer to the designated vendor to join the selected labor cloud if the designation vendor is not a member of the selected labor cloud; and
send the invitation to the designated vendor.

14. The system of claim 10, wherein membership requirements for a labor cloud comprise at least one of:
signed agreement;
availability;
background check;
certification;
company type;
document;
drug testing compliance;
eSignature;
industry;
insurance;
license;
location;
maximum abandoned assignments;
maximum canceled assignments;
maximum one-time deliverables;
skill assessment; and
verification.

15. The system of claim 10, wherein a number of the labor clouds are publicly accessible through an interface by any vendor.

16. The system of claim 10, wherein a number of the labor clouds are publicly accessible through an interface only by vendors invited by the customer.

17. The system of claim 10, wherein a number of the labor clouds are accessible only by the customer.

18. The system of claim 10, wherein the vendor is an independent contractor.

19. A computer program product for vetting payments, the computer program product comprising:
a number of non-volatile computer readable storage media having program instructions embodied therewith, the program instructions executable by a number of processors to perform the steps of:
creating a number of labor clouds, wherein each labor cloud has a number of specified membership requirements;
populating the labor clouds with a number of vendors who meet the specified membership requirements specified for each labor cloud;
receiving, through a user interface, a selection from a customer of a labor cloud from among the number of labor clouds to form a selected labor cloud;
receiving, through the user interface, a designation by the customer of vendor to form a designated vendor;
receiving, through the user interface, a payment request from the customer for the designated vendor;
determining if the designated vendor is a member of the selected labor cloud;
holding payment if the designated vendor is not a member of the selected labor cloud; and
submitting payment to the designated vendor according to the payment request only upon confirmation that the designated vendor has joined the selected labor cloud.

20. The computer program product of claim 19, wherein the labor clouds self-regulate and monitor member compliance with current membership requirements.

21. The computer program product of claim 19, wherein the customer can manually override membership requirements to add a vendor to a labor cloud.

22. The computer program product of claim 21, further comprising instructions for:
receiving, through the user interface, an invitation from the customer to the designated vendor to join the selected labor cloud if the designation vendor is not a member of the selected labor cloud; and
sending the invitation to the designated vendor.

23. The computer program product of claim 19, wherein membership requirements for a labor cloud comprise at least one of:
signed agreement;
availability;
background check;
certification;
company type;
document;
drug testing compliance;
eSignature;
industry;
insurance;
license;
location;
maximum abandoned assignments;
maximum canceled assignments;
maximum one-time deliverables;
skill assessment; and
verification.

24. The computer program product of claim 19, wherein a number of the labor clouds are publicly accessible through an interface by any vendor.

25. The computer program product of claim 19, wherein a number of the labor clouds are publicly accessible through an interface only by vendors invited by the customer.

26. The computer program product of claim 19, wherein a number of the labor clouds are accessible only by the customer.

27. The computer program product of claim 19, wherein the vendor is an independent contractor.
